(19) United States
(12) Patent Application Publication
(10) Pub. No.: US 2021/0269292 A1
(43) Pub. Date: Sep. 2, 2021

(54) SYSTEM AND METHOD FOR SUPPORTING VERTICAL MEMBERS

(71) Applicant: KEVIN GUO, WARREN, NJ (US)

(72) Inventor: KEVIN GUO, WARREN, NJ (US)

(21) Appl. No.: 16/805,697

(22) Filed: Feb. 29, 2020

(51) Int. Cl. B66F 3/10; B66F 3/18; A01G 9/12

(52) U.S. Cl. CPC B66F 3/10; A01G 9/122; B66F 3/18

(57) ABSTRACT

A system and method for supporting vertical members is disclosed. The invention is comprised of an adjustable jack post with angled flanges on each end that allow it to support leaning vertical members, such as but not limited to bent trees and swollen retaining walls etc. The adjustable jack post can be expanded or retracted under load manually by means of a hand crank that engages a bevel and worm gear system located proximally on the post. An object of the invention is to support and/or correct the angle of vertical members. For example, a user wishing to correct a leaning tree after a storm can anchor one end of the post in the ground, brace the other end against the tree and expand the post slowly over time using the hand crank allowing it to grow upright once again.

### FIELD OF THE INVENTION

The present invention generally relates to jack posts. More specifically to jack posts with angled terminal ends.

### BACKGROUND

Jack posts have been used to support vertical members for centuries. Modern jack posts generally consist of telescopic, tubular, braces and have three primary parts: the main cylinder known as the post, the jack screw and plates on each end. Both ends are normally fitted with metal flanges that provide additional support. Most jack posts are split in two near the middle, with the upper end carrying the jack designed to slide within the lower portion. Adjustments to length are usually made by pulling a pin and sliding the two sections within each other, re-inserting the pin to lock them, and then using the internal screw jack to make fine adjustments. Jack posts are typically used to support existing horizontal beams while supports are removed or repaired. Many such posts offer a means for adjusting widths. U.S. Pat. No. 8,001,733B2 Adjustable jack post. U.S. Pat. No. 2,570,282A disclosed an adjustable floor leveling device. U.S. Pat. No. 6,591,564B2 teaches of a ground-anchor brace system for modular buildings. U.S. Pat. No. 91,564B2 disclosed a ground-anchor brace system for modular buildings. U.S. Pat. No. 6,334,279B1 teaches of adjustable outrigger-type posts for manufactured homes. United States paten No. US20040182982A1 disclosed conventional column jacks for foundations. U.S. Pat. No. 2,812,077A disclosed a wall jack While a majority of these posts available on the market offer support at 90-degree angles, a few allow users to support members at various angles. U.S. Pat. Nos. 1,410,380A, 2,583,945A, 2,229,521A and 1,482,846A disclosed angled posts for tree felling but these are not designed as permanent support structures.

### SUMMARY OF THE INVENTION

The device herein disclosed and described provides a solution to the shortcomings in the prior art through the disclosure of an adjustable jack post with angled flanges on each end. An object of the invention is to support leaning, vertical members. For example, if a tree is blown over in a wind storm and a property owner wants to save the tree and make it upright once again, they can position the post at an angle and prevent it from falling over more. Other examples can include correcting the angle of walls and signs etc.

Another object of the invention is to provide a means to allow users to anchor one end of the post into the ground while the other end supports the vertical member. In the above example, one end of the jack post has a shovel-shaped flange that digs into the ground to prevent movement while the other end has a curved, Y-shaped flange with a lip that can support a tree. In another example a flat-shaped flange can support a leaning wall.

Another object of this invention is to provide a means to expand or retract when under load. The jack post has a worm gear inside the body that engages a bevel gear that can be turned by a manual hand crank. The gear ratio is designed to allow a user to exert several tons of force to expand the post and move vertical members such as trees or retaining walls etc. in order to make them upright once again.

Another object of the aforementioned invention is to allow a user the jack post to be compact when not in use. The aforementioned hand crank can also be used to make the jack post smaller thus more amenable for storage.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention in operation.

FIG. 2 shows a front view of the invention.

FIG. 3 shows a side view of the invention.

FIG. 4 shows an exploded view of the invention.

FIG. 5 shows other embodiments of the invention.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

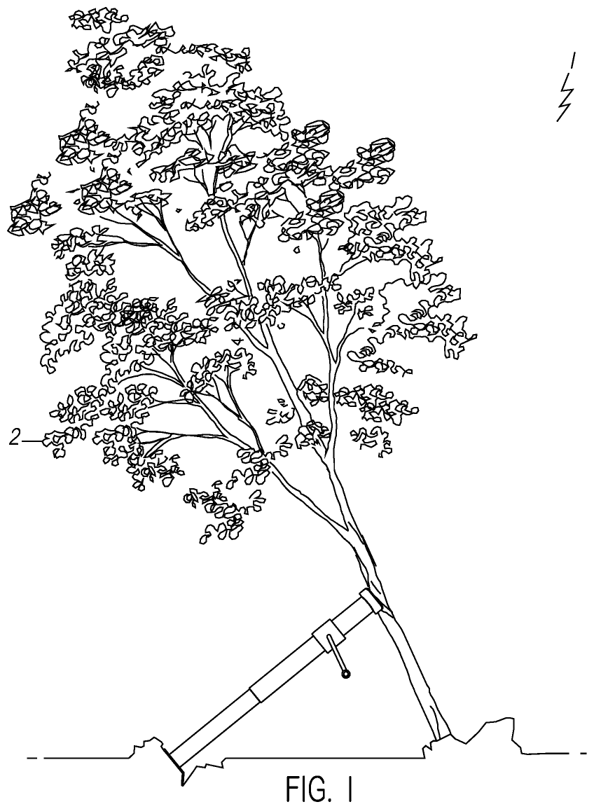

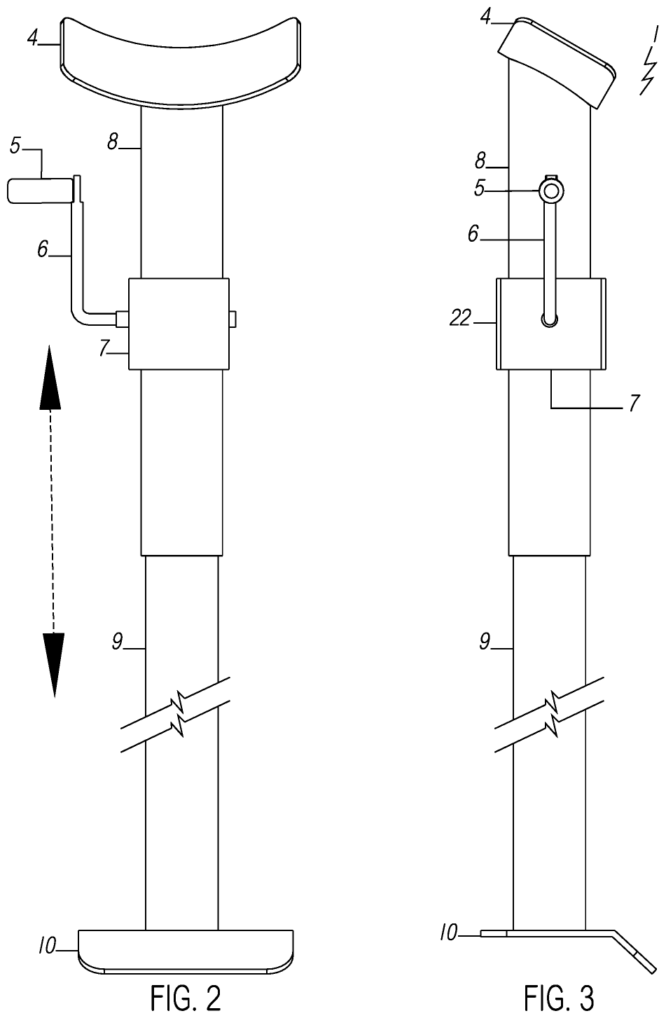

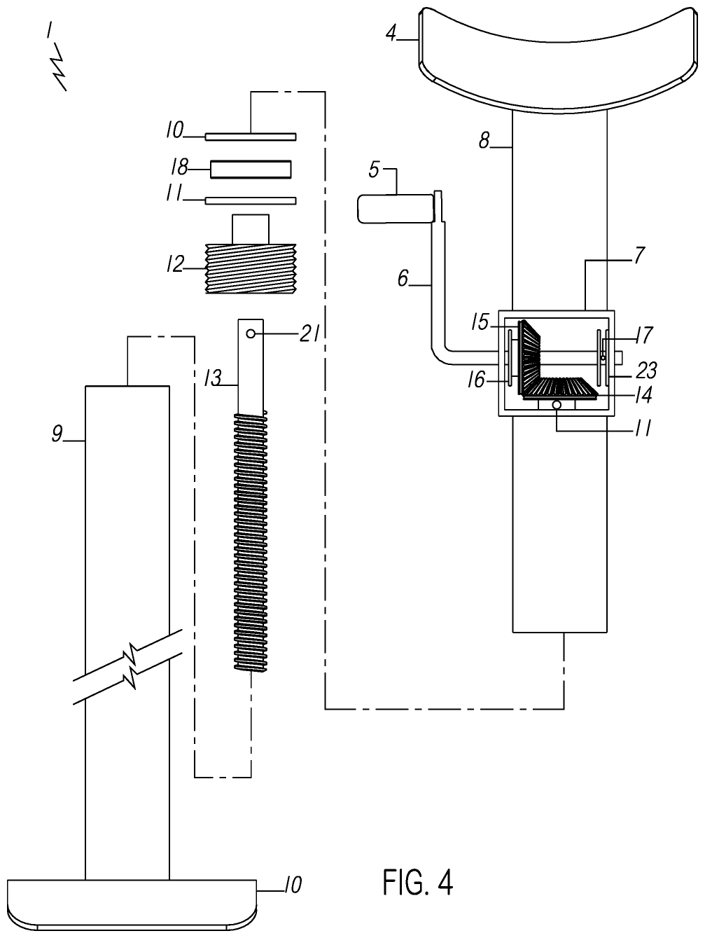

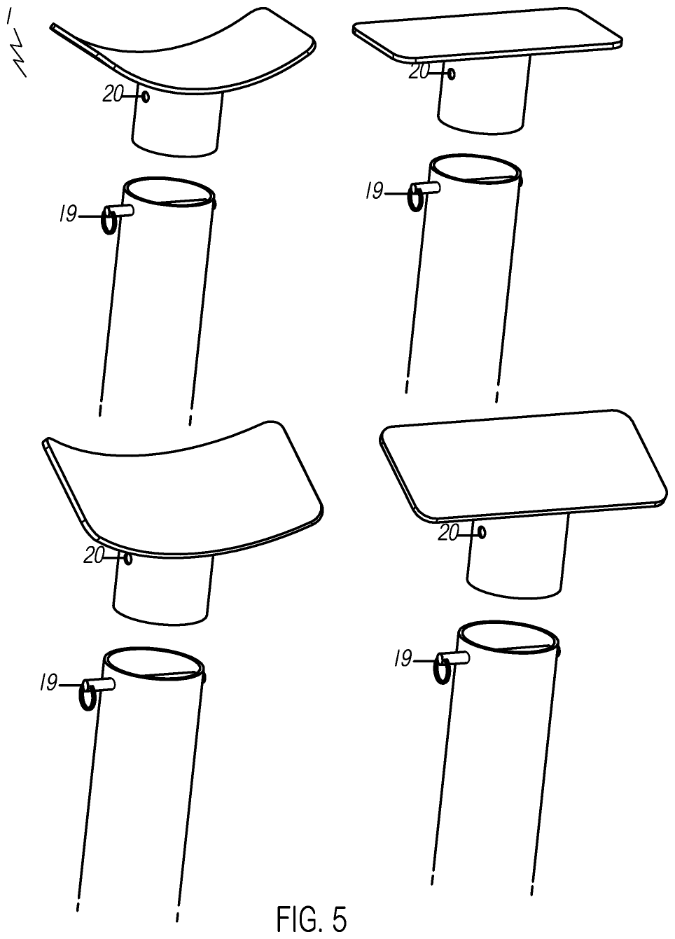

FIG. 1 showing the preferred embodiment of the invention 1 comprised of an adjustable jack post 5 with angled flanges being installed in the ground to support a leaning tree 2. FIG. 2 and FIG. 3 showing a front view and side view of the invention respectively generally comprised of at least two, interlocking sleeves (upper sleeve 8 and lower sleeve 9) having flanges (curved flange 4 and shovel flange 10) on terminal ends and a gearbox 7 (with square-shaped covers 22) with hand crank 6 (having grip 5) located proximally. The aforementioned sleeves 8 and 9, flanges 4 and 10, gearbox 7 and hand crank 6 all being made of a rigid metal such as but not limited to steel, stainless steel, aluminum and the like. The adjustable jack post being slidably extended and retracted by means of said hand crank 6 connected to bevel gears 15 and 14 inside gearbox 7 that engage worm gear 13. The aforementioned curved flange 4 having an angle of at least but not limited to a 30 degree angle apart from the longitudinal axis of upper sleeve 8 and shovel flange 10 also having an angled portion at least but not limited to 30 degrees apart from shovel flange 10's flat portion (relative to lower sleeve 9's longitudinal axis) as shown in FIG. 4. showing an exploded view with said worm gear 13 with aperture 21 on a distal end being configured along the longitudinal axis of lower sleeve 9 and engaging threaded nut 12 as well as bearing 12, washers 10 and 10 that are rigidly affixed to lower sleeve 9. Said worm gear 13 also being made of a rigid material such as but not limited to steel etc.

FIG. 4 also showing an open view of the gearbox 7 and hand crank 6 connected to vertical bevel gear 15 and engaging in horizontal bevel gear 14. Said hand crank 6 extending through said gear box 7 and vertical bevel gear 15 with washer 16 there between. The terminal end of said hand crank 6 inside gear box 7 also having aperture and 17 pin disposed between two washers 23 preventing the hand crank 6 from being removed from gear box 7. Horizontal bevel gear 14 being connected to worm gear 13 by means of pin 11 engaging aperture 14 that when hand crank 6 is rotated, the vertical and horizontal bevels turning worm gear 13 which engages threaded nut 12 and expanding the jack post. The figure also showing curved flange 4 being configured perpendicular to the longitudinal axis and tilted at an angle of at least but not limited to 30 degrees away from the longitudinal axis of upper sleeve 8. The resulting overall shape of curved flange 4 having a shape disposed to receive round objects as well as flat objects. Shovel flange 10 also being configured perpendicular to the longitudinal axis of lower sleeve 9 and having an angled portion allowing it to anchor into substrates such as but not limited to soil, sand gravel and the like. Other embodiments of the invention may include but not be limited to: sleeves having various diameters and lengths; other gear members and types (such as rack and pinion etc.); various-shaped, interchangeable flanges—depending upon the applications or supports needed; and a plurality of crank methods (such as electrical motors, engines etc.). FIG. 5 showing other embodiments of the invention having flanges of various shapes and sizes that can be selectively affixed to the ends of upper sleeve 9 and lower sleeve 8 with orifices configured to receive releasable clips 19 therein.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. An adjustable jack post comprising:
a) An upper sleeve;
b) A lower sleeve;
c) A curved flange;
d) A shovel flange;
e) A gear box; and
f) A hand crank.

2. The adjustable jack post of claim 1 wherein the upper sleeve having a diameter larger than the and lower sleeve.

3. The adjustable jack post of claim 1 wherein the upper sleeve having a distal end with the curved flange and a distal end of the lower sleeve having the shovel flange.

4. The adjustable jack post of claim 1 wherein the upper sleeve containing the gearbox.

5. The adjustable jack post of claim 1 wherein the gearbox containing horizontal and vertical bevel gears.

6. The gear box of claim 1 wherein the horizontal gear of claim 5 having an aperture and a pin.

7. The adjustable jack post of claim 1 wherein the hand crank has an aperture, pin and washers.

8. A method for supporting vertical members. The method comprised of the following steps:
a) anchoring one end of the adjustable jack post into the ground;
b) positioning another end of the adjustable jack post against a vertical member; and
c) adjusting the length of the adjustable jack post.

9. The method for method for supporting vertical members of claim 8 wherein the anchoring being performed with the additional step of inserting the shovel flange of claim 1 into the ground.

10. The method for method for supporting vertical members of claim 8 wherein the positioning being performed with the additional step of inserting the curved flange of claim 1 against the vertical member.

11. The method for method for supporting vertical members of claim 8 wherein the adjusting the length of the adjustable jack post is achieved by turning the hand crank of claim 1.

12. The method for method for supporting vertical members of claim 8 wherein the turning the hand crank of claim 9 occurring when the device is not under load and under load.
